(19) United States
(12) Patent Application Publication
(10) Pub. No.: US 2006/0101100 A1
(43) Pub. Date: May 11, 2006

(54) Document management of nested references

(76) Inventors: Chandra Sekhar Konidena, Andhra Pradesh (IN); Srinivas Reddy Challa, Andhra Pradesh (IN); Anjani Prabhakar Chapparapu, Andhra Pradesh (IN); Bhaskara Chary Dharmavarapu, Andhra Prades (IN); Neelima Avadhanula, Andhra Pradesh (IN)

Correspondence Address: BROMBERG & SUNSTEIN LLP, 125 SUMMER STREET, BOSTON, MA, 02110-1618, US

(21) Appl. No.: 11/204,767

(22) Filed: Aug. 15, 2005

Related U.S. Application Data
(60) Provisional application No. 60/602,018, filed on Aug. 16, 2004.

(51) Int. Cl. G06F 12/00; G06F 17/30

(52) U.S. Cl. 707/204

(57) ABSTRACT

A computer program product and document management system for managing nested references. The document management system scans each document within the document management system to ascertain if the document includes a nested reference. If a second document is a nested reference of a first document, the document management system creates an indicia of reference indicating the second document is referenced within the first document within a data structure, such as a database. As documents are checked-out, edited, and checked-in to the document management system, the system will update the data structure with any changes such as file name, revision number, and the document management system may also update a pointer to the memory location within the document management system associated with the updated nested reference. Additionally, the document management system can update any links or embedded information in a master document related to the nested reference if the nested reference has been edited.

### CROSS REFERENCE TO RELATED APPLICATIONS

The present application claims priority from U.S. provisional patent application 60/602,018 entitled Nested Document Management filed on Aug. 16, 2004, which is incorporated herein by reference in its entirety.

### TECHNICAL FIELD AND BACKGROUND ART

The present invention relates to document management systems and more specifically to nested documents.

Document management systems allow client computers to access documents stored in a common location on a server computer. A user requests access to a document and the document management system checks the status of the document. Generally, a document is either checked-in or checked-out. If the document is checked-in, the document management system allows the user to check-out the document and the document management system sends a copy of the document to the client's computer through a network connection. Until the user checks the document back in, no one else can access the checked-out document.

Over the past several years, documents have increased in complexity and are no longer simply ASCii text. Documents contain format instructions, as well as other information. The extensible markup language XML has moved away from merely formatting and presenting text to characterizing and describing data. References and links to other documents can now be made within other documents. Simply by selecting a link embedded within a document, the embedded link will access the embedded document and open up the document in an appropriate application. In other cases, a document may contain text from another document wherein a reference to the second document is found within the first document.

A problem occurs when a nested reference changes, since the link within the master document to the nested reference is not automatically updated and the link information can only be corrected with manual intervention. On large projects this act can be time consuming, wherein one document may be linked to many other documents which in turn may be linked to other documents.

### SUMMARY OF THE INVENTION

The application discloses a client/server-based document management system accounting for nested references within documents and updating the association between the master document and the nested reference when a user edits the nested reference. The document management system includes computer code for managing nested references. The computer code associates a first document with a second document creating an indicia of reference to the second document wherein the second document is referenced within the first document. The indicia of reference may be a record or entry within a database object that indicates that the second document is nested within the first document. The computer code stores the indicia of reference in this record for the first document. In certain embodiments of the invention, the second document is referenced in the first document as a link. The link may be associated with the memory address of the second document.

Once the document management system has registered the first document, the second document, and has a record of the nested reference of the second document within the first document, the document management system can receive requests for checking documents out. For example, a client application may send a request to a server computer that operates the document management system requesting the first document be checked-out. The document management system includes computer code for sending the first and second documents to a client computer originating the request for checking out the first document. The document management system checks out both documents because of the indicia of reference indicating that the second document is nested within the first document. After a user edits the second document and checks the second document back into the document management system, the document management system updates the indicia of reference within the document management database. The indicia of reference is updated to include reference to the new version of the second document. The document management system may also include computer code to edit the first document, so that the link to the second document points to the updated version of the second document.

The document management system may also include a client application residing on a client computer. The client application receives information about the state of the document management system including documents that are checked-in, checked-out and nested references. The client application may provide a graphical user interface for use by a user. The graphical user interface displays the indicia of reference between documents and allows for graphical selection of documents to check out. The graphical representation may be a hierarchical tree structure and the tree structure may show all editable documents. The tree structure connects master documents with their nested references. The document management system maintains a log indicating the documents that are checked-out and does not allow a user to check out documents that are checked-out by another user. When a user requests a document to check out, the client application sends the request to the server of the document management system and the document management system sends a copy of the requested documents to the client. In certain embodiments, the client application will include computer code for maintaining information regarding nested references of the local versions of checked-out documents and will update indicia of reference for documents when the local versions of the nested documents are edited. This information can be transferred back to the server of the document management system when the documents are checked back in.

The document management system can include computer code for checking in a document to a document repository of a document management system. When a user checks in a document, the document management system checks to see if the document is referenced within any other document within the document management system. If the answer is yes, the document management system will update the indicia of reference for each document that references the document currently being checked-in.

### BRIEF DESCRIPTION OF THE DRAWINGS

The foregoing features of the invention will be more readily understood by reference to the following detailed description, taken with reference to the accompanying drawings, in which:

FIG. 1 is a block diagram showing a client server environment employing a document management system;

FIG. 2 is a block diagram representing documents that contain nested references;

FIG. 3 shows data contained within the server regarding nested references within a document;

FIG. 4 shows a screen shot showing a client side graphical user interface showing various documents;

FIG. 5 shows a screen shot of an expanded tree structure of the documents shown in FIG. 4 showing the relationship between master documents and nested references;

FIG. 6 shows a screen shot showing documents that can be checked-in;

FIG. 7 is a flow chart of operations performed for managing nested references; and

FIG. 8 is a flow chart of operations performed for cyclic references.

### DETAILED DESCRIPTION OF SPECIFIC EMBODIMENTS

Definitions. As used in this description and the accompanying claims, the following terms shall have the meanings indicated, unless the context otherwise requires: the term “document” shall refer to a file that is created in a native application outside of the document management system. The term “reference” and “referenced” shall refer to either a link to a document that is within another document or a document that is embedded within another document.

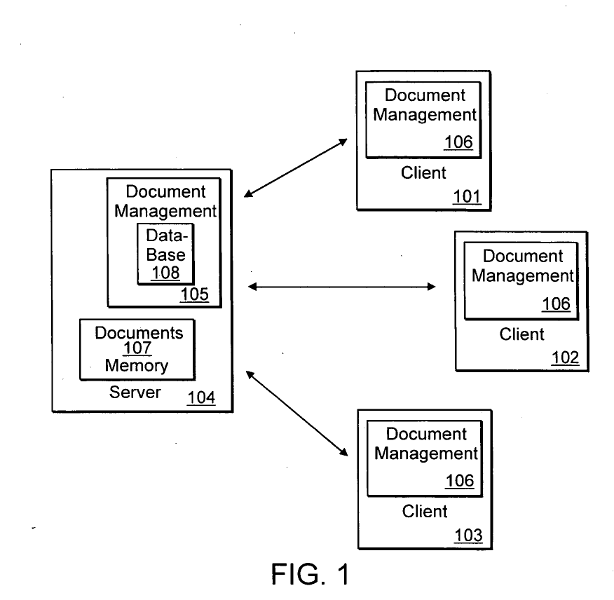

FIG. 1 is a block diagram showing a client server environment employing a document management system. Document management systems allow operators at remote computer terminals to edit and save documents on a commonly shared server. An example of a document management system is the SmartPlant Foundation Document Management System produced by Intergraph Software Technologies Company. In such a document management system, the documents are copied and stored at the server and distributed upon request to the computer of a requesting user. The document management server keeps track of documents as they are selected by a requesting client computer. This can be performed by having an associated database that includes information about the status of each document (checked-in, checked-out, history, versions, title etc.) and if the document is checked-out by a requesting computer, an identifier that indicates either the computer making the request or the identity of a user of the requesting computer. If a document has been checked-out, the document management system will not allow another user at a remote client computer to obtain and edit the document. In FIG. 1, multiple client computers 101, 102, 103 are connected to the server computer 104 that is operating the document management system 105. The document management system 105 includes software that runs on the server computer 104 and also software that runs on the client computer 106. The server software keeps track of requests for documents 107 from the client computers and maintains a database listing 108 of the status of the documents 107, including whether or not the document has been checked-out. The present invention extends upon this system to allow the document management system to keep track of nested references and to automatically update a database listing concerning nested references. The system will also update the individual documents if a nested reference has changed.

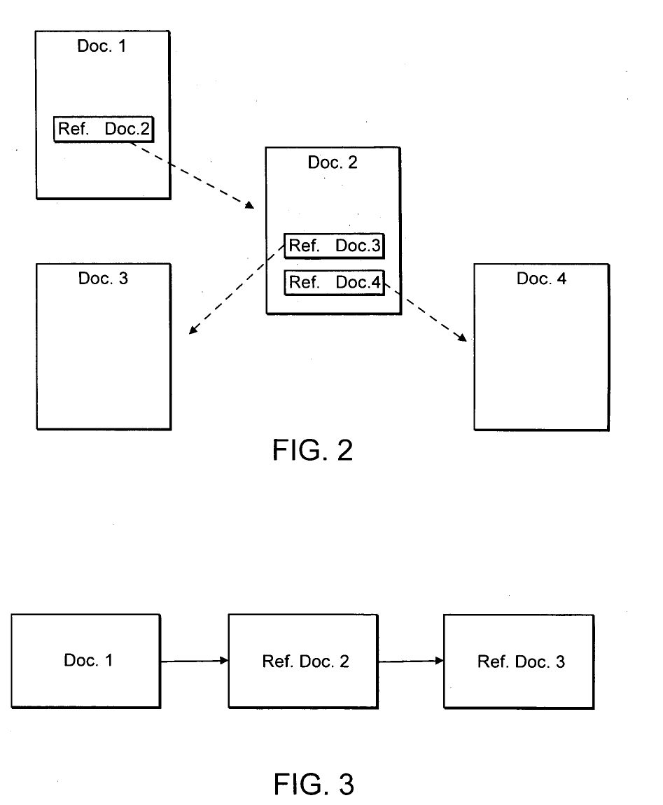

FIG. 2 is a block diagram representing documents that contain nested references. A second document that is referenced within the body of a first document is a nested reference. A reference that is nested includes a link to another document. For example, document 1 includes a nested reference to document 2. Document 2 includes nested references to both document 3 and document 4. When document 1 is opened within an application, such as a word processor, document 1 may contain a link that is selectable by the user of the word processor program that will access document 2. In certain nested references, the reference may include only a portion of another document and the application program may automatically access the document associated with the nested reference and incorporate the portion of the referenced document within the document being viewed. For example, in a word processing document, there may be a nested reference to a second document that contains a plurality of tables containing the addresses of teachers and students. The first document may have a nested reference that links to the table that contains the addresses of the teachers. When the user opens up the word processing document, the table containing the addresses of teachers will be viewable within the document as it is displayed on a display device. As expressed above, one problem resulting from a nested reference within an original document occurs when a nested document is updated (i.e. the file name changes, the version changes etc.), however the updates are not reflected in the original/master document. Therefore, in prior art systems, the updates needed to be performed manually within the original document.

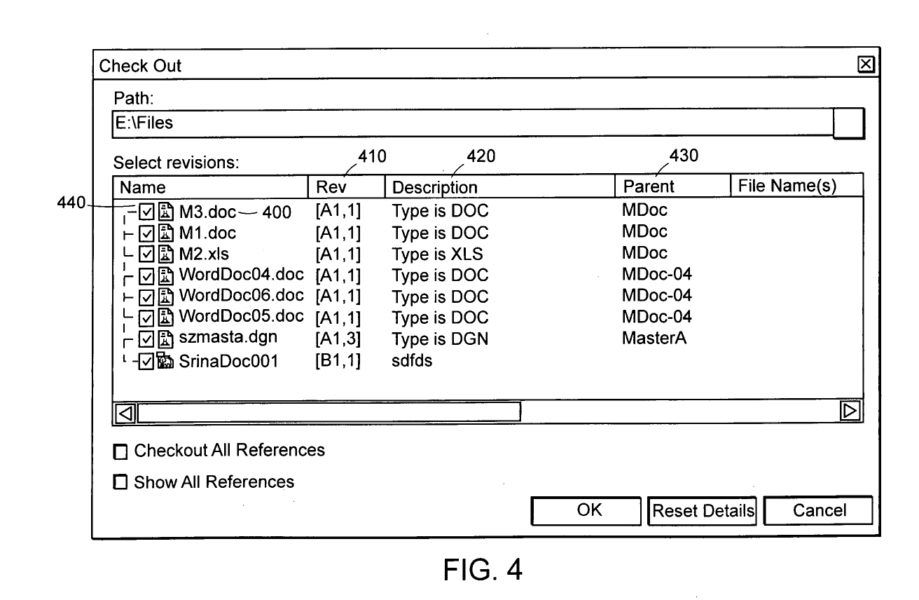

As shown in FIG. 3 modifications are made to the document management program to include a database that contains reference revision information. The document management system scans each document and locates all nested references/links within each document. The document management system can use a procedure call to an API for identifying the nested references. The Smart Foundation Document Management Platform includes an STM extraction API that allows the document management system to open different files types from companies, such as AutoCad(.DWG), Intergraph (.IGR) and Microsoft (.DOC). The document management system uses the spmexten.exe executable file from the STM extraction API to create a file that contains a listing of the nested references within a file. The procedure takes two parameters: the first parameter is the input file name to be searched and the second parameter is the output file name containing the nested reference list.

The document management system uses the information in the output file to create a data structure, such as a database wherein the reference relationships are stored. The data base is constructed from a series of connected objects. An exemplary data structure is provided below.

Class Document Revision
{

ID:
Name:
Description:
Revision:
Version: 1 to 100 (increment by 1 on Checkout)
Checked-out= True/False

}
Class Document Wrapper
{

ID:
Name:

Description:
LocalDocumentName:
LocalHostname:

ReflD:

}
Relation RefDocument
{
MasterDocumentID;
ReferenceDocumentID;

Each document is part of a document wrapper class. The document wrapper class indicates which document revision class that the document belongs to. The document revision class is a database class that tracks the version of the documents using the document wrapper class. For example, if a data processing document (.doc) has a nested reference to spreadsheet (.xls) document, there is a document wrapper object for the spreadsheet and a document wrapper object for the data processing document. Both document wrapper objects share the same RefID. The hierarchical relationship between two documents sharing the same RefID is defined by Relation RefDocument. In the above example, the .xls spreadsheet document is the nested reference document to the data processing master document (.doc). If the spreadsheet document was not nested within the data processing document, then each would have a separate RefID indicating that they belong to different document wrapper objects. The document revision class maintains the revision information for each document wrapper object. Thus, the revision status of both master and reference document can be found within the common document revision object.

In such a data structure, all related documents can be graphically displayed in a tree structure. For example, as shown in FIG. 3, document 1, which is the master document contains a reference to document 2. This reference is maintained within the database objects along with the nested reference information. In certain embodiments, the data structure may include a link variable that may be the address within memory where the latest version of the document is stored. When a client computer logs into the document management system, the revision information for each document is sent along with the document wrapper information to the client. The client includes a program that can display the database information in a tree structure that shows each of the documents and each document that is referenced within the document. Additionally, the client program displays information regarding whether the document is checked-in or check-out and to whom the document is checked-out. As shown in the exemplary data structure, the document revision object contains both the revision information and the check-out status information. The user may select to check-out a document. The client machine contacts the document management system and loops through each of the reference revisions and validates the check out path and the user checking out the document. The document management system will then check-out the requested document and any document that is referenced within the document. The system may be designed so that any document that contains a reference will be checked-out. For example, if document 1 contains a nested reference to document 2 and document 2 contains a nested reference to document 3, documents 1, 2, and 3 will be checked-out by the client. In other embodiments, the ability to select whether to check out nested reference documents may be provided to the user of the client machine.

The document management system allows different users of the document management system to have different privileges regarding access to a document. For example, the document management system allows for documents to be signed-in and signed-off. If a document is signed-in, only certain users can edit the document, but other users may view the document. For example, the creator of a document will have management responsibility for the document and can change the status of a document between signed-in and signed-off. If a document is signed-off, the document is released and any user can access and edit the document.

In a nested environment, a nested document can be in a signed-in state while a master document is in a signed-out state. As such, the document management system will allow the master document and the nested reference to be checked-out by a user, however the user can edit the master document and only view the nested reference. When the client application receives both the master document and the associated nested references, the client program identifies the status of each document (signed-in, signed-out). Based upon the status of the document, the client application will only release documents that are marked as signed-out to the native application for the document. For documents that are signed-in, the client program will launch a viewer program that does not include/allow editing functions.

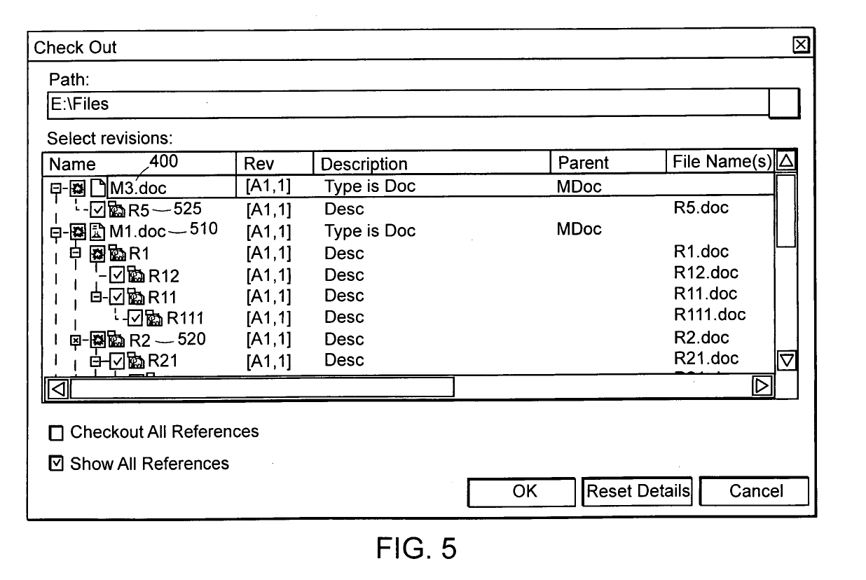

FIG. 4 shows a screen shot of a graphical user interface on the client computer presenting the various documents that can be checked-out and the relationship of the document to their master document. As shown in FIG. 4 the client side graphical user interface is a tree structure. If a user selects to check-out a document or documents, the document management system will cause a new screen to be presented wherein a user can see all documents that are nested within the selected document or documents. As shown, the information that is presented includes the name of the document 400, the revision number 410, a document description 420 and the parent document's name 420. In such an embodiment, a user has the ability to check-out multiple documents at the same time and will also be able to check-out the documents that are nested within the selected documents. In FIG. 4 all of the documents are initially selected as indicated by the box containing the check mark 440.

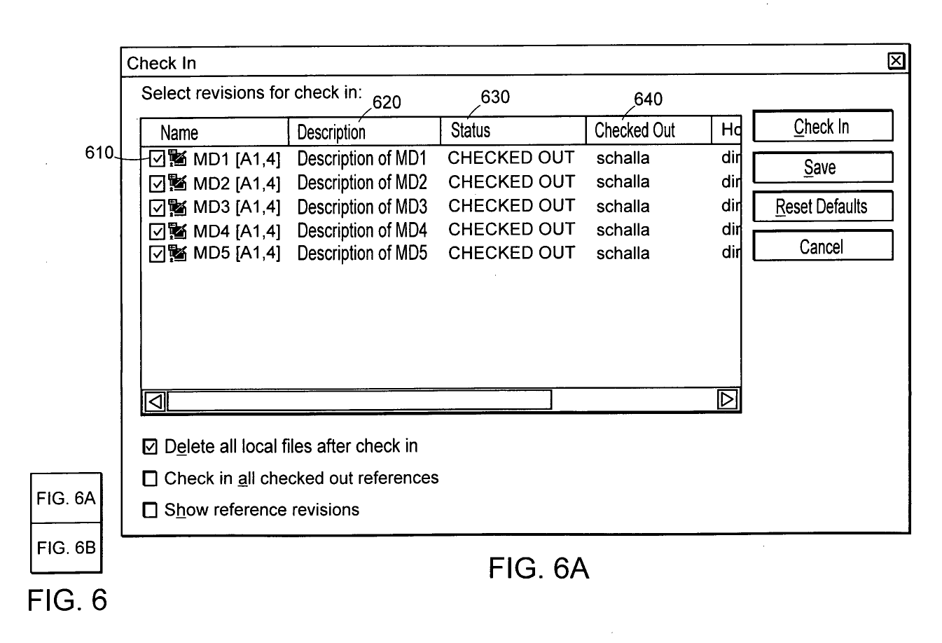

FIG. 5 shows a screen shot expanding the tree structure shown in FIG. 4. As shown in FIG. 5, documents M3 400, M1 510 and R2 520, as indicated by the checked boxes are selected either automatically by the system or by a user. The related documents that are nested within these documents are also displayed. In one embodiment, all of the nested documents are automatically selected to be checked-out. As shown in FIG. 5, document M3 400 has document R5 525 nested within it. Additionally, the revision number is also presented. When a user at the client side selects all of the documents that he wishes to check-out, a command is sent from the client side to the document management server. The document management server will receive the communication and will make copies of the selected documents. Additionally, the document management system will update its database and will indicate that the documents are being checked-out and will also indicate the user that is checking-out the documents. The documents will then be transmitted to the client. A user can then edit and update the documents.

Similarly, once documents have been selected to be checked-out and the documents have been edited, the documents can be checked back in. The user will indicate that he has completed revising the documents and desires to check the documents back in. A command will be sent to the server for this purpose. The server will confirm that the documents that the user is requesting to check-in have been checked-out. The server will then request the revision information from the client computer. The computer program operating on the client's computer will transfer the files back to the document management server and the document management system will update the database with the new revision information. The document management system will then update links to any of the documents that have been checked back in and revised. For example, if document M3 and R5 are checked back in, the document management system will search to see if any other documents reference M3 or R5. If a document, for example A1, is found with a reference to R5, the link for A1 pointing to document R5 will be updated so that both the document A1 and the database record for A1 points to the updated version of R5. Thus, when document A1 is next checked-out, the document management system will indicate that R5 is a nested reference and it will allow the user to check out the updated version of R5. Once the user checks out document A1 and the updated version of R5 and the server sends copies of the files to the client's computer, the client can edit document A1 and he will be provided with the updated version of document R5 within document A1. Thus, the link within document A1 is updated in addition to the document management system's database record for A1.

The document management system performs this check-in process by accessing the database record for the document being checked-in and checking to see what nested relationships the previous version of the document had. The document management system updates the database record to point to the new version of the document and identifies any new nested references that a user has added to the document during the editing process. The document management system then updates the database record. The database record is part of the previously described tree structure. The document management system accesses the tree structure and goes down and up the tree to see if any other database records need to be updated. Upon identifying a database record that needs to be updated, the document management system checks the status of the document associated with the database record to determine if the document is checked-in or checked-out. If the document is checked-in, the database record is updated and the document is accessed and the link within the document is updated. If a user had checked out the document, the document management system updates and flags the database, so that when the user checks the document back in, the document management system will update the link within the document.

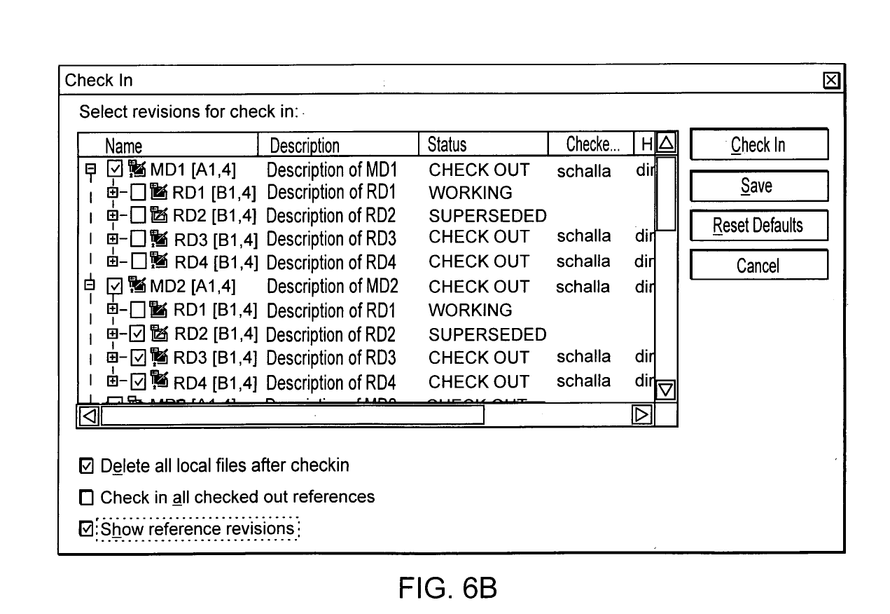

FIG. 6 shows a screen shot of a computer program that operates on the client's computer. Prior to the screen shot of FIG. 6, the user indicates that he wishes to check-in documents. The user is then provided with the graphical user interface of FIG. 6. The user may select the documents that he wishes to check-in by graphically moving a cursor over box 610 and selecting the box which is indicated by a check mark. The graphical user interface indicates the name of the document 620, along with the status of the document (checked-out) 630 and to whom the document is checked-out 640 (schalla in this example). After selecting the documents to be checked-in, the user will transmit a command to the server by selecting the button marked check-in 650. The server receives the request to check the documents back in and confirms that the document has-been checked-out. The client's computer sends the documents to the server. The server either replaces the documents that have been checked-out or adds the newly revised versions to the document management system and updates its database. As previously indicated, the server will also check if other documents reference the checked-in documents. If there are other checked-in documents that reference the checked-out documents, the server will access the checked-in documents and update the links to the checked-out documents.

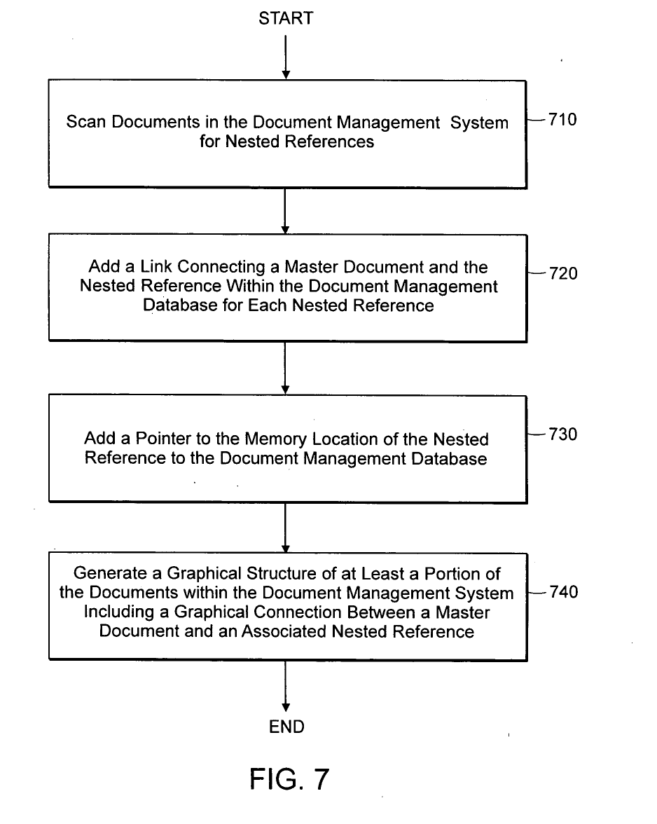

In another embodiment of the invention, when documents are modified and checked-in, the database updates the links between documents within the database. For example, if document B1 has been modified and is being checked-in, the document management system will check to see if any other documents reference document B1. If there is a document that references B1, say document C1, the pointer within the document management database will be updated to point to the updated version of B1. The document C1 will not be updated. However, the document management system will maintain the same name for the updated version of document B1, and thus, when another user checks-out document B1 the updated version of document C1 will be downloaded and accessible from within document B1. As shown in FIG. 7, upon initialization of the document management system that includes management of nested references, the program on the server will scan each document. The documents will be scanned for format information that indicates that the document references another document 710. For example, the scanning process may look for code such as references to directories, such as C:, D: or references to typical document extensions such as .doc, .pdf, .xls. When the scanning program comes upon an indication of a nested document, the program will add a link within its database indicating that the parent document includes a nested document 720 and will further find and include within the database a pointer to that document 730. From this information, the document management system can generate the tree structure that is sent to a client accessing the document management system 740.

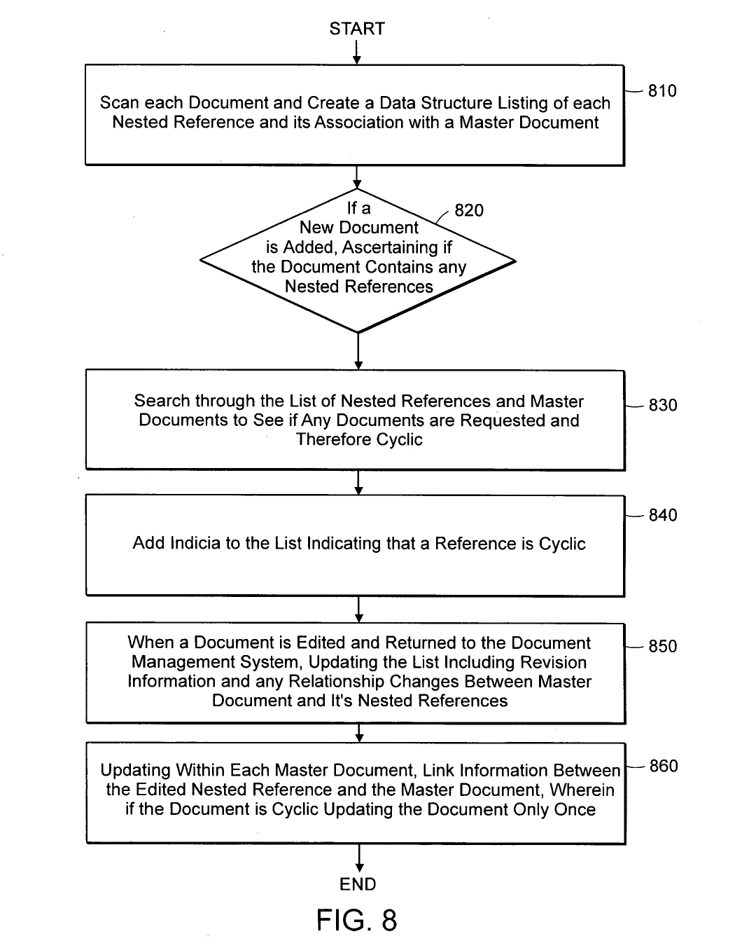

In certain embodiments of the document management system, cyclical relationships between master documents and nested documents are accounted for in the database containing reference relationships as shown in FIG. 8. It is possible that a nested reference may refer back to the master document or a first nested reference may refer to a second nested reference which itself refers back to the first nested reference. The document management system should account for such relationships so as to avoid an endless loop when updating the database containing the relationships between documents and updating the links within the individual documents. If a master document (MD1) has a nested reference (NR1) which itself has a nested reference to (MD1) the documents have a cyclical relationship. If documents are already in existence before the document management system is installed, the document management system will search each document for nested references and will create a database containing the reference relationships between documents as previously stated 810. This database can be viewed as a tree type structure and the document management system can navigate both down and up the tree. When a new document is created and added into the document management system, the document management system will ascertain if there are any nested references 820 and will then navigate both in an upward and downward direction through the tree structure associated with the nested references to ascertain if there is a cyclical relationship 830. The system will then mark in the database whether there is or is not a cyclical relationship 840. When a document is subsequently edited and checked back in to the document management system, the document management system will update the nested reference database (with revision information, name changes, and update any of the child-parent relationships of the tree structure) 850 and all of the links within the nested reference documents in both an upward and downward direction of the tree structure 860. If the document that is checked is associated with a cyclic reference, the document management system will only update each of the associated references one time. As such, the document management system will not cycle through in an endless loop.

In one embodiment, the invention may be implemented as a computer program product for use with a computer system. Such implementation may include a series of computer instructions fixed either on a tangible medium, such as a computer readable media (e.g., a diskette, CD-ROM, ROM, or fixed disk), or transmittable to a computer system via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable media with accompanying printed or electronic documentation (e.g., shrink wrapped software), preloaded with a computer system (e.g., on system ROM or fixed disk), or distributed from a server or electronic bulletin board over the network (e.g., the Internet or World Wide Web).

In other embodiments of the invention, the document management system may be embodied as hardware or firmware (hardware and software).

Although various exemplary embodiments of the invention have been disclosed, it should be apparent to those skilled in the art that various changes and modifications can be made which will achieve some of the advantages of the invention without departing from the true scope of the invention. These and other obvious modifications are intended to be covered by the appended claims.

What is claimed is:

1. A computer program product for managing nested references, the computer program product containing computer code thereon that is executable on a computer, the computer code comprising:
computer code for associating a first document with a second document creating an indicia of reference to the second document wherein the second document is referenced within the first document;
computer code for storing the indicia of reference in a record for the first document within a document management database.

2. The computer program product according to claim 1, wherein the second document is referenced in the first document as a link.

3. The computer program product according to claim 2, wherein the link is associated with a memory address of the second document.

4. The computer program product according to claim 1, further comprising:
computer code for receiving a request for checking-out the first document.

5. The computer program product according to claim 4, further comprising:
computer code for sending the first and second documents to a client computer originating the request for checking-out the first document.

6. The computer program product according to claim 1, further comprising:
computer code for updating the indicia of reference within the document management database after the second document has been edited.

7. The computer program product according to claim 6, further comprising:
computer code for checking-in at least the second document by updating a field within the document management database wherein the indicia of reference is also updated after at least the second document is checked-in.

8. The computer program product according to claim 1, further comprising:
computer code for updating the reference within the first document to the second document after the second document has been edited.

9. The computer program product according to claim 1, further comprising:
computer code for providing a graphical user interface displaying the indicia of reference between documents and allowing graphical selection of a document to check-out.

10. The computer program product according to claim 9, wherein the graphical user interface is a hierarchical tree structure.

11. The computer program product according to claim 10, further comprising:
computer code for presenting in the graphical interface all documents that are editable.

12. The computer program product according to claim 1, further comprising:
computer code for checking-in a document to a document repository wherein if there are any other documents associated with the document being checked-in, the document management database is accessed and the indicia of reference is updated.

13. The computer program product according to claim 1, further comprising:
computer code for storing the first and the second document in memory associated with a server.

14. The computer program product according to claim 4, further comprising:
computer code for indicating in the document management database that both the first and second documents have been checked-out in response to receiving the request.

15. A computer program product for use with a document management system that accounts for nested references within documents, the computer program product containing computer code thereon that is executable on a computer, the computer code comprising:
computer code for requesting at least a partial listing of documents within the document management system; and
computer code for displaying nested relationships between documents from the at least partial listing of documents.

16. The computer program product according to claim 15, further comprising:
computer code for requesting a document to be checked-out from the document management system.

17. The computer program product according to claim 16, further comprising:
computer code for receiving a copy of the requested document and a copy of associated nested references wherein the copies are local versions.

18. The computer program product according to claim 17, further comprising:
computer code for updating all local versions of files that contain an association with an edited document; and
computer code for transmitting the updated local versions of the files to a remote server.

19. A computer program product for managing a second document nested within a first document, the first document having an associated reference to the second document, the computer program product containing computer code thereon that is executable on a computer, the computer code comprising:
computer code for determining a change in the second document;
computer code for locating the first document that references the second document; and
computer code for updating the associated reference to the second document based on the change to the second document.

20. The computer program product according to claim 19, wherein the associated reference to the second document is a link in the first document.

21. The computer program product according to claim 20, wherein the link is associated with a memory address of the second document.

22. The computer program product according to claim 19, wherein the associated reference to the second document is contained within a database record for the first document.

23. The computer program product according to claim 19, further comprising:
computer code for receiving a request for checking-out the first document.

24. The computer program product according to claim 23, further comprising:
computer code for determining that the first document contains a nested reference to the second document.

25. The computer program product according to claim 24, further comprising:
computer code for sending to a client computer originating the request, the first and second documents based on the determined nested reference.

26. The computer program product according to claim 25, further comprising:
computer code for checking-in at least the second document.
